(19) United States
(12) Patent Application Publication
(10) Pub. No.: US 2004/0120019 A1
(43) Pub. Date: Jun. 24, 2004

(54) Object short-range projection light conduction structure

(76) Inventor: Chin-Hsing Chou, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/327,134

(22) Filed: Dec. 24, 2002

(51) Int. Cl. B60Q 1/26

(52) U.S. Cl. 359/1; 362/494; 362/544; 362/545; 362/800

(57) ABSTRACT

A light conduction structure that generates short range projection for an object to create aesthetic sense of vision by emitting dazzling, fantastic and colorful lights; includes an inner layer provided with a reflective outer side in while; a middle layer made of color, translucent material in dazzling colors and making light passing through it to become gender, wraps up the outer side of the inner layer; an outer layer made of see-through material wraps up the outer side of the middle layer; and a light conduction holder wrapping up the outer peripheries of the inner, the middle and the outer layers contains an insertion channel to accommodate a plurality of light emission devices.

### BACKGROUND OF THE INVENTION

(a) Field of the Invention

The present invention relates to an object short-range projection light conduction structure, and more particularly, to a light conduction holder to receive insertion of the outer peripheries respectively of an inner, a middle and an outer layers, and lights emitted from light emission devices contained in the light conduction holder pass through and are reflected by the three layers to display colorful lights, thus to produce dazzling and fantastic esthetic sense in view, and is applicable to structures of various objects.

(b) Description of the Prior Art

In the prior art, the focus is on the geometric changes of an object in terms of the aesthetic sense of its appearance, and much less attention is paid to light projection to highlight the beauty of such geometric style. In fact, given with a proper change in the light projection to the geometric style or the profile of an object, the consumer will have a very different and comfortable visual experience with such an object. Therefore, to increase sales volume of a product, it takes to improve competition strength of such product and give it more expected values. To do that, it is necessary to improve the visual contact of the product with innovative and dazzling light variations so to catch the eyes of the consumers, and to encourage their strong motivation for the buy.

### SUMMARY OF THE INVENTION

The primary purpose of the present invention is to provide a light conduction structure that generates short-range projection for an object to create aesthetic sense of vision by emitting dazzling, fantastic and colorful lights. To achieve the purpose, the structure comprises an inner layer provided with a reflective outer side in while; a middle layer made of color, translucent material in dazzling colors and making light passing through it to become gender, wraps up the outer side of the inner layer; an outer layer made of see-through material wraps up the outer side of the middle layer; and a light conduction holder wrapping up the outer peripheries of the inner, the middle and the outer layers contains an insertion channel to accommodate a plurality of light emission devices.

### BRIEF DESCRIPTION OF THE DRAWINGS

FIG. 1 is sectional view of the present invention.

FIG. 2 is an exploded view of a first preferred embodiment of the present invention.

FIG. 3 is a perspective view of the first preferred embodiment of the present invention when assembled.

FIG. 4 is a sectional view of the assembly of the first preferred embodiment of the present invention.

FIG. 5 is a front view of the first preferred embodiment of the present invention in use.

FIG. 6 is a front view of a second preferred embodiment of the present invention in use.

FIG. 7 is a sectional view of an assembly of a third preferred embodiment of the present invention.

FIG. 8 is a view of the assembly of the third preferred embodiment of the present invention in use.

FIG. 9 is a sectional view of an assembly of a fourth preferred embodiment of the present invention.

FIG. 10 is a view of the assembly of the fourth preferred embodiment of the present invention.

### DETAILED DESCRIPTION OF THE PREFERRED EMBODIMENTS

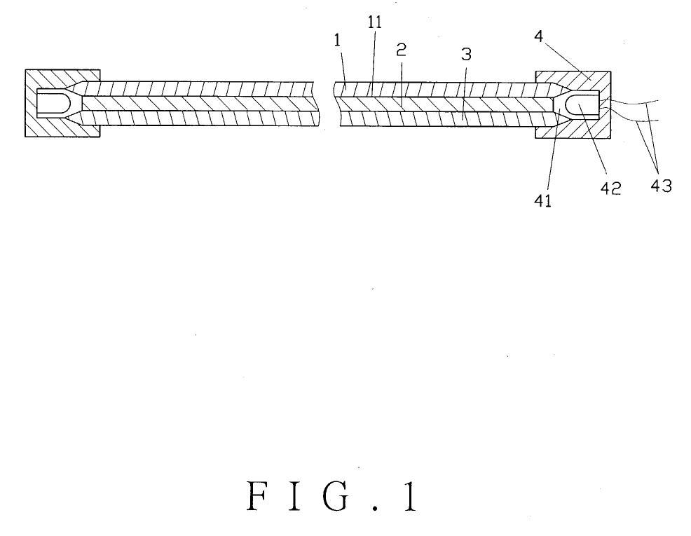

Referring to FIG. 1, the present invention essentially comprises an inner layer (1), a middle layer (2), an outer layer (3) and a light conduction holder (4).

The inner layer (1) made in the shape of a rear-view mirror (e.g. the one used in an automobile) has an outer side and a periphery. A reflective section (11) provided on the outer side has its surface painted in white either by plating or by spraying.

The middle layer (2) is provided with an outer side and a periphery and wraps up the outer side of the inner layer (1). The middle layer (2) is made of color, translucent material; or both an inner and an outer sides of the middle layer (2) are coated with a course of translucent paint so to create versatile and dazzling colors and to make the light passing through it to become gentle without being irritating to one's eyes when the present invention is adapted to a car. The middle layer (2) is made in a shape similar to that of the inner layer (1) to indicate a shape of a rear-view mirror to wrap up the inner layer (1). The length of the periphery of the middle layer (2) is slightly shorter than that of the inner layer (1).

The outer layer (3) provided with a periphery to wrap up the outer side of the middle layer (2) is made of see-through material. The shape of the outer layer (3) is similar to that of the middle layer (2) to indicate a shape of a rear-view mirror to wrap up the middle layer (2). The length of the periphery of the outer layer (3) is slightly longer than that of the middle layer (2).

The light conduction holder (4) receives the insertion respectively of the peripheries of the inner layer (1), the middle layer (2) and the outer layer (3). The light conduction holder (4) may be made in any shape to correspond with the inner layer (1), the middle layer (2) and the outer layer (3). An insertion channel (41) is provided in the light conduction holder (4) to receive the insertion of the peripheries respectively of the inner layer (1), the middle layer (2) and the outer layer (3). The insertion channel (41) contains a plurality of light emission devices (42), e.g. LEDS, arranged at equal space from one another. A power cord (43) extends from the light emission devices (42) to connect to an electric system (such as one in the car).

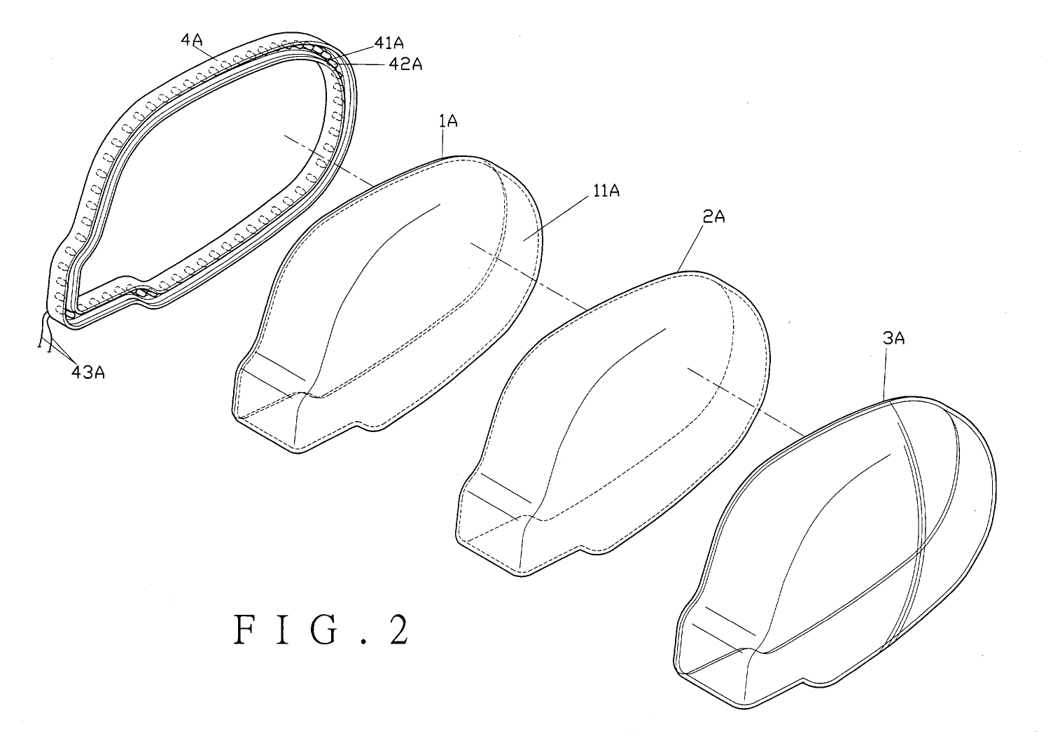

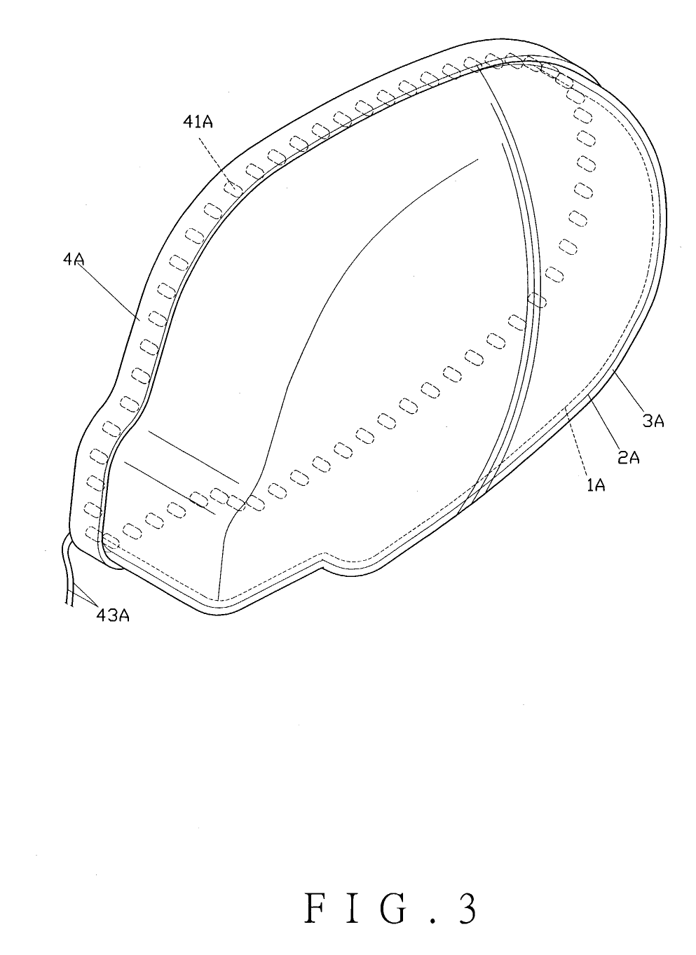

As illustrated in FIGS. 2 and 3, a first preferred embodiment of the present invention essentially comprises an inner layer (1A), a middle layer (2A), an outer layer (3A) and a light conduction holder (4A). The inner layer (1A) made in the shape of a rear-view mirror (e.g. the one used in an automobile) has an outer side and a periphery. A reflective section (11A) provided on the outer side has its surface painted in white either by plating or by spraying.

The middle layer (2A) is provided with an outer side and a periphery and wraps up the outer side of the inner layer (1A). The middle layer (2A) is made of color, translucent material; or both an inner and an outer sides of the middle layer (2A) are coated with a course of translucent paint so to create versatile and dazzling colors and to make the light passing through it to become gentle without being irritating to one's eyes when the present invention is adapted to a car. The middle layer (2A) is made in a shape similar to that of the inner layer (1A) to indicate a shape of a rear-view mirror to wrap up the inner layer (1A). The length of the periphery of the middle layer (2A) is slightly shorter than that of the inner layer (1A).

The outer layer (3A) also provided with a periphery to wrap up the outer side of the middle layer (2A) is made of see-through material. The shape of the outer layer (3A) is similar to that of the middle layer (2A) to indicate a shape of a rear-view mirror to wrap up the middle layer (2A). The length of the periphery of the outer layer (3A) is slightly longer than that of the middle layer (2A).

The light conduction holder (4A) receives the insertion respectively of the peripheries of the inner layer (1A), the middle layer (2A) and the outer layer (3A). The light conduction holder (4A) is made in the shape to correspond with the rear-view mirror shape of the inner layer (1A), the middle layer (2A) and the outer layer (3A). An insertion channel (41A) is provided in the light conduction holder (4A) to receive the insertion of those peripheries respectively of the inner layer (1A), the middle layer (2A) and the outer layer (3A). The insertion channel (41A) contains a plurality of light emission devices (42A), e.g. LEDS, arranged at equal space from one another. A power cord (43A) extends from the light emission devices (42A) to connect to an electric system (such as one in the car).

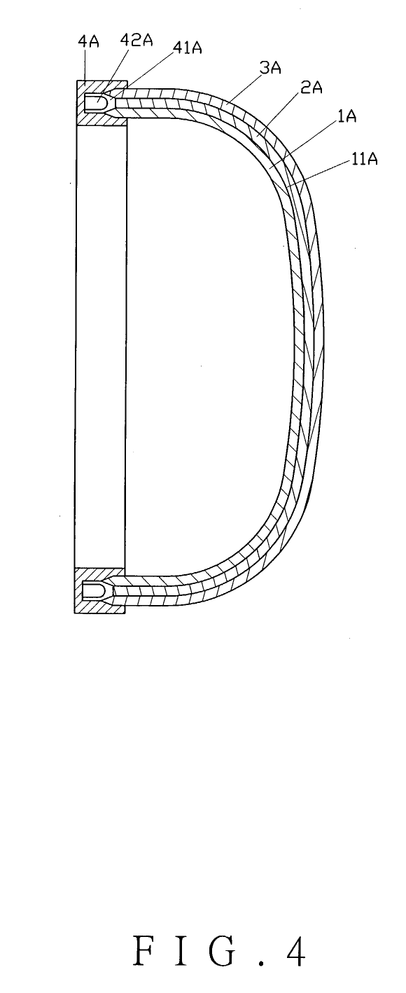

Upon assembling as illustrated in FIG. 4, the middle layer (2A) wraps up the outer side of the inner layer (1A), and the outer layer (3A) wraps up the outer side of the middle layer (2A) so that all the three layers (1A, 2A, 3A) are overlapped on one another. All the three layers (1A, 2A, 3A) are then as a unit inserted with their peripheries into the insertion channel (41A) of the light conduction holder (4A) for the light conduction holder (4A) to fix all the three layers (1A, 2A, 3A) in position to complete the assembly.

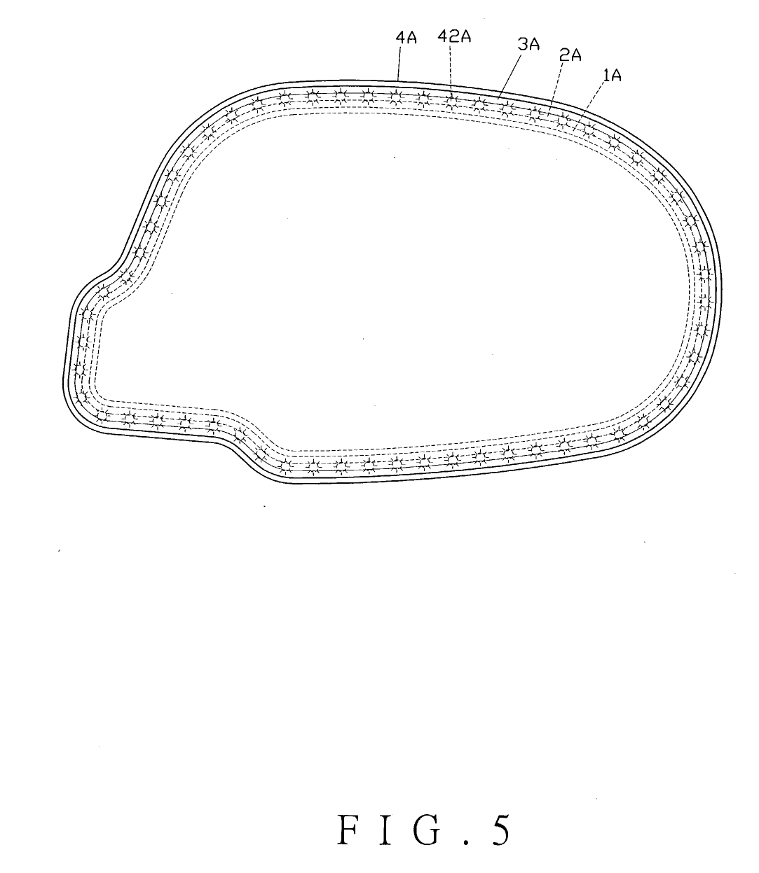

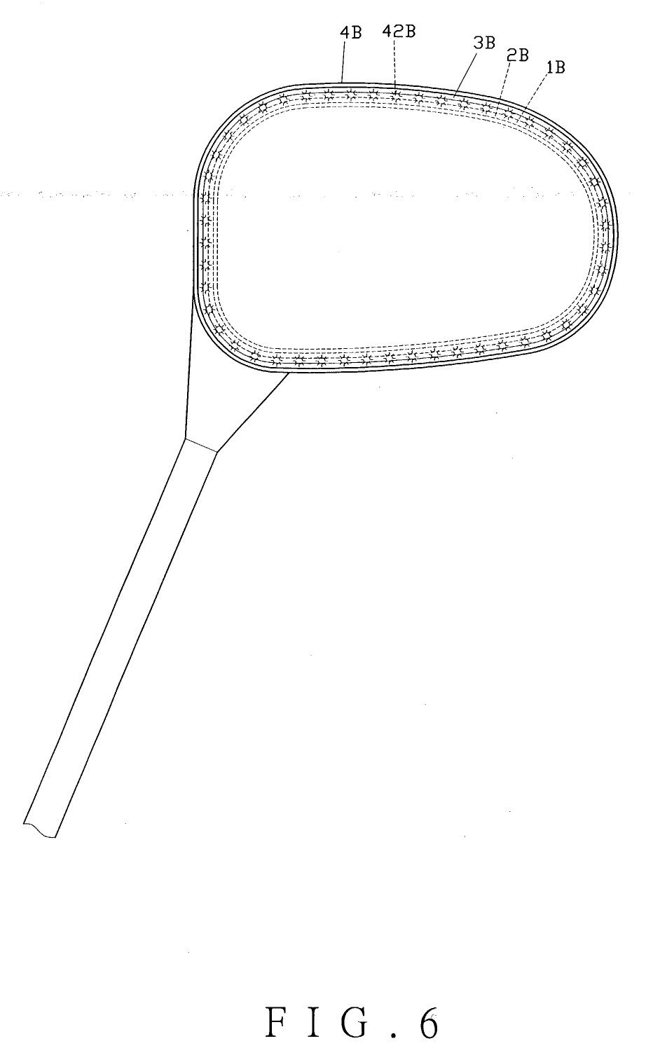

While in use as illustrated in FIG. 5, once the electric system (such as one in the car) is started, the light emission devices (42A) in the light conduction holder (4A) are lighted. When the light beam reaches the reflective section (11A), it is completely reflected since the reflective section (11A) is painted in white. As the light beam is reflected and reaches the middle layer (2A), it passes through the middle layer (2) coated with dazzling colors and becomes gentle to avoid irritating to one's eyes on the road when the first preferred embodiment is adapted to an automobile. Furthermore, the colorful light beam is projected by the see-through outer layer (3A) to create aesthetic sense of visual effect, sparkling yet tender to upgrade the quality of the lamps of the automobile, and increase its expected value and sales volume. A second preferred embodiment of the present invention as illustrated in FIG. 6 also essentially comprises an inner layer (1B), a middle layer (2B), an outer layer (3B) and a light conduction holder (4B), similar to those of the first preferred embodiment, adapted as a rear mirror to a motorcycle.

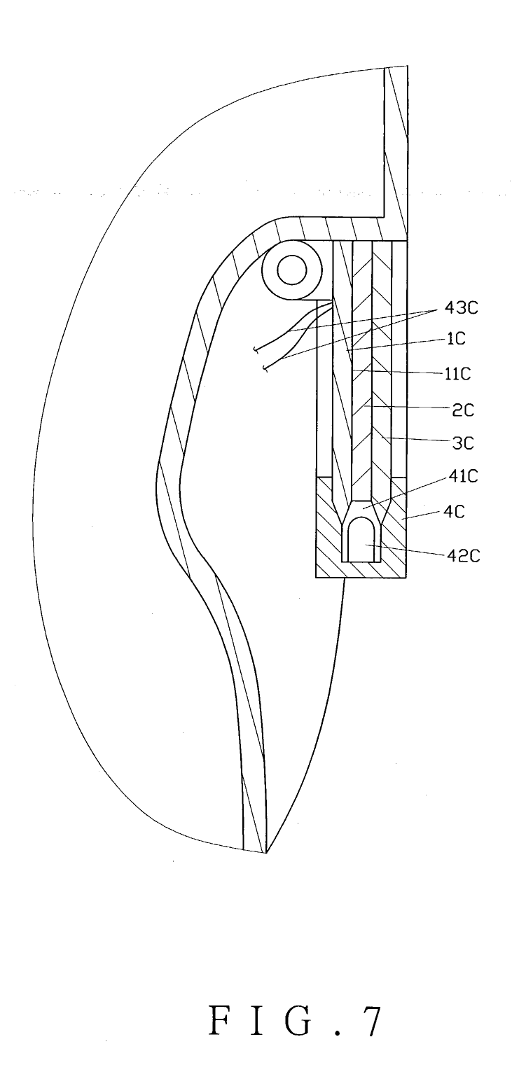

Now referring to FIG. 7, a third preferred embodiment of the present invention adapted to a handle (such as a door handle of an automobile) essentially comprises an inner layer (1C), a middle layer (2C), an outer layer (3C) and a light conduction holder (4C). The inner layer (1C) having an outer side and a periphery is made in a sheet shape. A reflective section (11C) is provided on the outer side of the inner layer (1C) and the surface of the reflective section (11C) is painted in white.

The middle layer (2C) is provided with an outer side and a periphery and wraps up the outer side of the inner layer (1C). The middle layer (2C) is made of color, translucent material to make the light passing through it becoming gentle without being irritating to one's eyes. The middle layer (2C) is made in a shape similar to that of the inner layer (1C) to indicate a sheet shape and wraps up the inner layer (1C).

The outer layer (3C) provided with a periphery to wrap up the outer side of the middle layer (2C) is made of see-through material. The shape of the outer layer (3C) is similar to that of the middle layer (2C) to indicate a sheet shape to wrap up the middle layer (2C).

The light conduction holder (4C) receives the insertion respectively of the peripheries of the inner layer (1C), the middle layer (2C) and the outer layer (3C). The light conduction holder (4C) is made in a reverse U-shaped to match up that of the door handle of an automobile. An insertion channel (41C) is provided in the light conduction holder (4C) to receive the insertion of the peripheries respectively of the inner layer (1C), the middle layer (2C) and the outer layer (3C). The insertion channel (41C) contains a plurality of light emission devices (42C), e.g. LEDS, arranged at equal space from one another. A power cord (43C) extends from the light emission devices (42C) to connect to an electric system (such as one in the car).

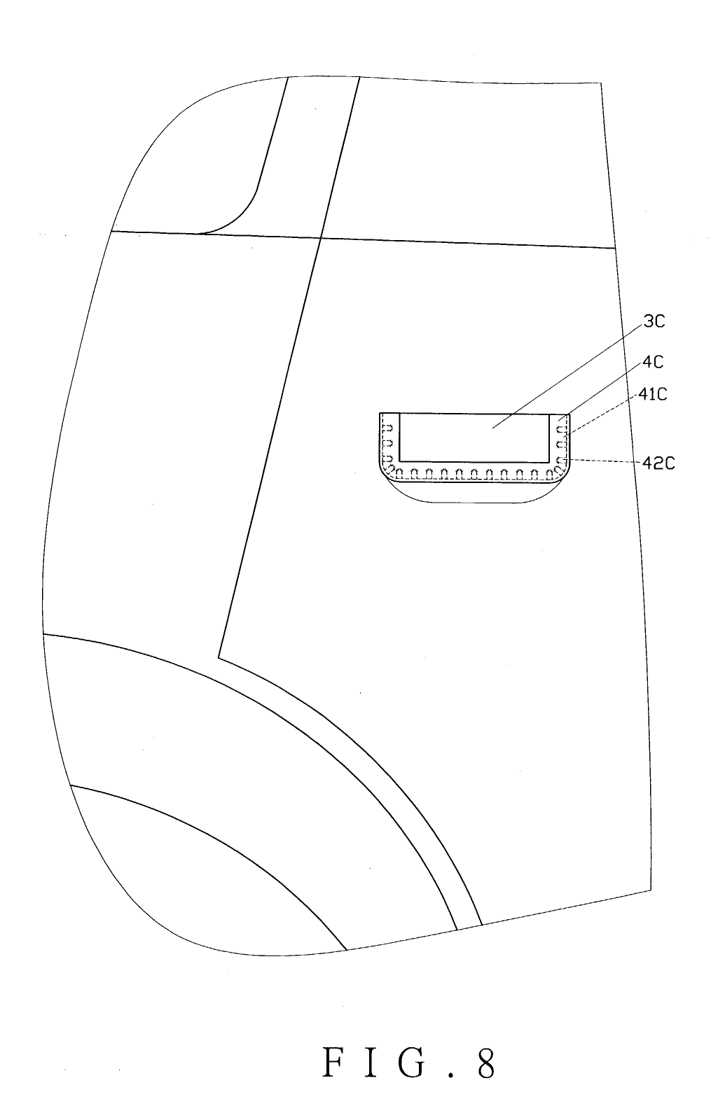

When in use as illustrated in FIG. 8, once the electric system (such as one in the car) is started, the light emission devices (42C) in the light conduction holder (4C) are lighted to project colorful lights, thus to create aesthetic sense of visual effect without irritating one's eyes, sparkling yet tender to upgrade the quality of the door handle of the automobile, and increase its expected value and sales volume.

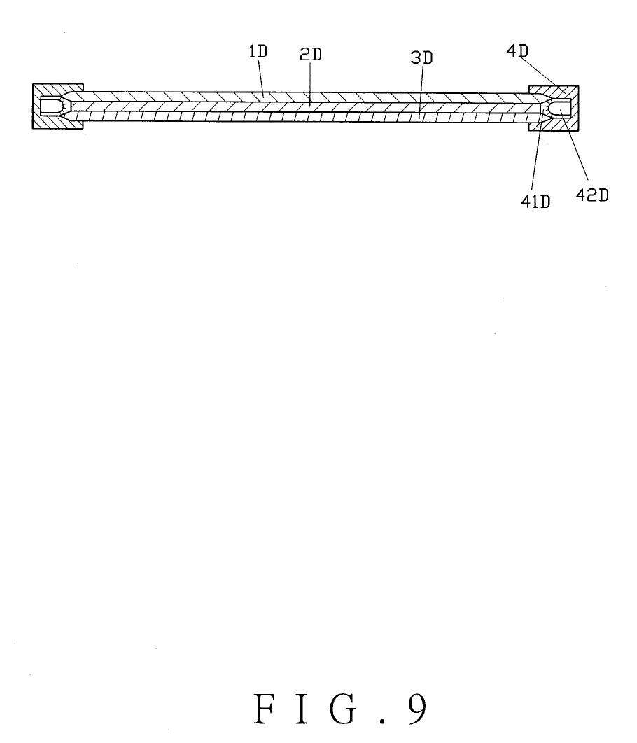

As illustrated in FIG. 9, a fourth preferred embodiment adapted to a photo frame comprises an inner layer (1D), a middle layer (2D), an outer layer (3D) and a light conduction holder (4D). The inner layer (1D) having an outer side and a periphery is made in a rectangular sheet shape. A reflective section (11D) is provided on the outer side of the inner layer (1D) and the surface of the reflective section (11D) is painted in white.

The middle layer (2D) is provided with an outer side and a periphery and wraps up the outer side of the inner layer (1D). The middle layer (2D) is made of color, translucent material to make the light passing through it becoming gentle without being irritating to one's eyes. The middle layer (2D) in a shape similar to that of the inner layer (1D) to indicate a rectangular sheet shape and wraps up the inner layer (1D).

The outer layer (3D) provided with a periphery to wrap up the outer side of the middle layer (2D) is made of see-through material. The shape of the outer layer (3D) is similar to that of the middle layer (2D) to indicate a sheet shape to wrap up the middle layer (2D).

The light conduction holder (4D) receives the insertion respectively of the peripheries of the inner layer (1D), the middle layer (2D) and the outer layer (3D). The light conduction holder (4D) is made in a stick shape to correspond with that of the photo frame. An insertion channel (41D) is provided in the light conduction holder (4D) to receive the insertion of the peripheries respectively of the inner layer (1D), the middle layer (2D) and the outer layer (3D). The insertion channel (41D) contains a plurality of light emission devices (42D) to be powered by cells (an art generally known to those who are familiar with the field, thus is not elaborated nor illustrated herein).

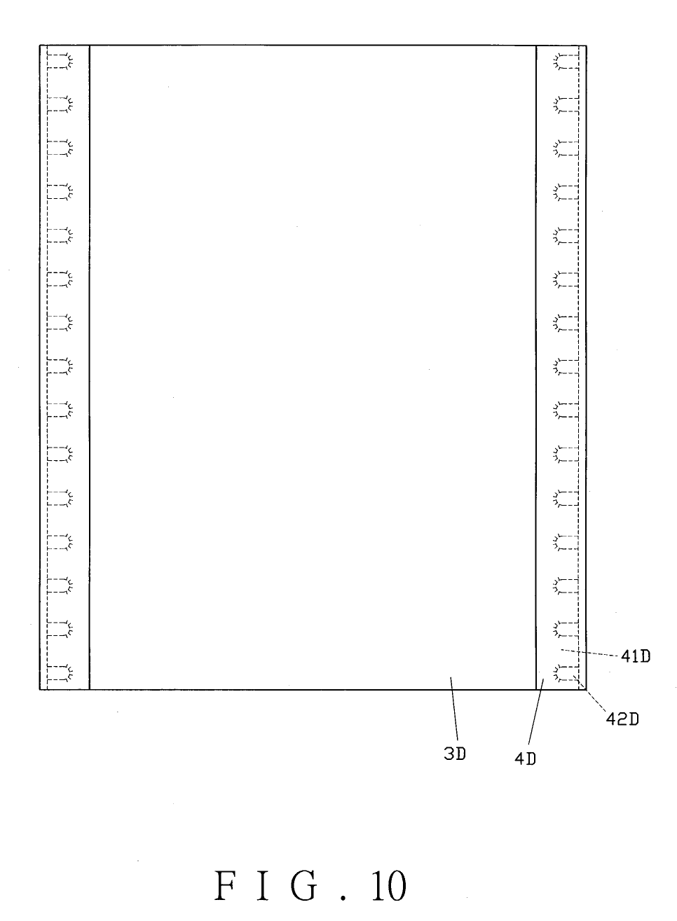

When in use as illustrated in FIG. 10, once the cells are connected, the light emission devices (42D) in the light conduction holder (4D) are lighted to project colorful lights, thus to create aesthetic sense of visual effect without irritating one's eyes, sparkling yet tender to upgrade the quality of the photo frame, and increase its expected value and sales volume.

The present invention may be adapted to structures of various types of objects. Therefore, it is be noted that any and all the preferred embodiments described in the specification shall in no way to limit the scope of what is to be claimed by the present invention and any replacement identical to or equivalent with the structural characteristics shall be included and protected by the scope of what is to be claimed by the present invention.

I claim:

1. An object short-range projection light conduction structure comprising an inner layer, a middle layer, an outer layer and a light conduction holder, wherein:
said inner layer having an outer side and a periphery, and a reflective section being provided on said outer side;
said middle layer having an outer side and a periphery and wrapping up said outer side of said inner layer, being made of translucent material;
said outer layer having a periphery and wrapping up said outer side of said middle layer, being made of see-through material;
said light conduction holder having an insertion channel, said insertion channel containing a plurality of light emission devices and wrapping up the peripheries respectively of said inner, said middle and said outer layers.

2. The object short-range projection light conduction structure as claimed in claim 1, wherein, said reflective section of said inner layer is painted in white.

3. The object short-range projection light conduction structure as claimed in claim 1, wherein, said middle layer is made of color, translucent material.

4. The object short-range projection light conduction structure as claimed in claim 1, wherein, said outer layer is made of see-through material.

5. The object short-range projection light conduction structure as claimed in claim 1, wherein, said inner layer, said middle layer, said outer layer and said light conduction holder are made in a shape of a rear-view mirror to be adapted to a rear-view mirror of an automobile or a motorcycle.

6. The object short-range projection light conduction structure as claimed in claim 1, wherein, said inner layer, said middle layer and said outer layer are made in a sheet shape, and said light conduction holder is made in a reverse U-shaped to be adapted to a door handle of an automobile.

7. The object short-range projection light conduction structure as claimed in claim 1, wherein, said inner layer, said middle layer and said outer layer are made in a rectangular sheet shape, and said light conduction holder is made in a stick shape to be adapted to a photo frame.

8. The object short-range projection light conduction structure as claimed in claim 1, wherein, said light emission devices are light emitting diodes.

9. The object short-range projection light conduction structure as claimed in claim 1, wherein, said light emission devices are arranged at equal space in said insertion channel.

10. An object short-range projection light conduction structure as claimed in claim 1, wherein, the length respectively of said inner layer and said outer layer is slightly longer than said periphery of said middle layer.

11. The object short-range projection light conduction structure as claimed in claim 2, wherein, said reflective section is painted in white by spraying.

12. The object short-range projection light conduction structure as claimed in claim 2, wherein, said reflective section is painted in white by plating.
